(19) United States
(12) Patent Application Publication
(10) Pub. No.: US 2023/0102064 A1
(43) Pub. Date: Mar. 30, 2023

(54) DISTRIBUTING STRUCTURE FOR A FUEL CELL WITH ANISOTROPIC GAS-DIFFUSION COEFFICIENTS

(71) Applicant: Robert Bosch GmbH, Stuttgart (DE)

(72) Inventors: Elisabeth Buehler, Tamm (DE); Harald Bauer, Ehningen (DE); Juergen Hackenberg, Sachsenheim (DE); Marcus Wegner, Leonberg (DE); Peter Lindner, Sersheim (DE)

(21) Appl. No.: 17/908,889

(22) PCT Filed: Jan. 5, 2021
(86) PCT No.: PCT/EP2021/050067

§ 371 Date: Sep. 1, 2022

(30) Foreign Application Priority Data
Mar. 2, 2020 (DE) 10 2020 202 637.8

(51) Int. Cl. H01M 4/88; H01M 4/86

(52) U.S. Cl. CPC H01M 4/8807; H01M 4/8605; H01M 4/8652; H01M 4/8668; H01M 4/8673; H01M 2008/1095

(57) ABSTRACT

invention relates to a distributing structure (10) for a fuel cell (1) in the form of a microporous layer, having: a multiplicity of particles (11), wherein the particles (11) are designed to provide the distributing structure (10) with mechanical stability and electrical conductivity, and wherein a multiplicity of pores (P) are formed between the particles (11) for the purposes of distributing reactants (H2, O2) through the distributing structure (10) and of discharging a product water (H2O), the invention providing, for this purpose, a multiplicity of fibres (12), which are distributed within the microporous layer such that the distributing structure (10) has a first diffusion coefficient (D1) in a first planar direction (x) in relation to the plane of extent (x, y) of the microporous layer, and that the distributing structure (10) has a second diffusion coefficient (D2) in a second planar direction (y) in relation to the plane of extent

### BACKGROUND

The invention relates to a distributing structure for a fuel cell in the form of a microporous layer according to the preamble of the independent device claim and to a corresponding fuel cell according to the coordinate independent device claim.

Known fuel cells (e.g., PEM fuel cells) are stacked into stacks of individual cells. Individual fuel cells usually comprise a hydrophilic (polymer) membrane with catalyst applied on both sides and with bordering hydrophobized gas diffusion layers (GDL) which are pressed between two corresponding gas distributor structures, known as bipolar plates. On reaction in the fuel cell, product water is formed on the cathode side. If the product water is not taken off, regions on the catalyst may become flooded. Condensed product water may in this case hinder the reactants from reaching the catalyst. There is a local reduction in the performance of the fuel cell in the flooded regions, and a reduction in the overall performance of the system. Moreover, such flooded regions are often zones or starting points for degradation effects such as corrosion, for example.

In order to prevent flooding of the regions on the catalyst, microporous layers of hydrophobic particulate materials, referred to as microporous layers (MPL), are usually disposed on the usually fibrous gas diffusion layers (carbon paper or simply CP) in order to be able to allow the reactants through always and to take off the product water.

### SUMMARY

The invention according to a first aspect provides a distributing structure for a fuel cell, in the form of a microporous layer, having the features of the independent device claim, more particularly from the characterizing part. The invention, according to a second aspect, further provides a corresponding fuel cell having the features of the coordinate independent device claim. Further features and details of the invention are apparent from the respective dependent claims, the description, and the drawings. Features and details described in connection with individual aspects of the invention are of course also valid in connection with the other aspects of the invention, and in each case vice versa, and so reference is and can always be made reciprocally in respect of the disclosure pertaining to the individual aspects of the invention.

The present invention according to the first aspect provides a distributing structure for a fuel cell, in the form of a microporous layer, more particularly a self-supporting microporous layer, comprising: a multiplicity of particles, where the particles are designed for providing mechanical stability and electrical conductivity of the distributing structure, and where between the particles a multiplicity of pores are configured for distributing reactants through the distributing structure and for taking off product water. For this purpose the invention provides a multiplicity of fibers which are distributed within the microporous layer in such a way, more particularly are mixed with the particles in such a way, that the distributing structure has a first (meaning effective) diffusion coefficient in a first planar direction in relation to the plane of extent of the microporous layer and that the distributing structure has a second (meaning effective) diffusion coefficient in a second planar direction in relation to the plane of extent of the microporous layer, where the first diffusion coefficient is higher than the second diffusion coefficient.

The fibers of the invention may be provided by elongate particulate materials and/or by fibrous materials.

The fibers of the invention may be provided proportionally to the particles, in, for example, a (weight) ratio of 0.1:1 to 10:1, more particularly 0.5:1 to 5:1, preferably 1:2 to 2:1.

The microporous layer of the invention may be produced as a film, foil or web, which may be trimmed into shape, in order to provide one or more microporous layers for one or more fuel cells.

The microporous layer of the invention is preferably self-supporting. This means that the microporous layer of the invention can be handled individually before it may be disposed between a bipolar plate and a catalyst layer of the membrane.

The distributing structure of the invention is designed in accordance with the invention in the form of a microporous layer (MPL); by means of the distributing structure of the invention it is possible advantageously to forgo a fibrous gas diffusion layer (GDL) within a fuel cell.

The distributing structure of the invention may be disposed at least on a cathode side and optionally on an anode side of the fuel cell or on an anode side and optionally on a cathode side of the fuel cell.

The fuel cell of the invention may be configured in the form of a fuel cell stack comprising a plurality of stacked fuel cells, preferably PEM fuel cells.

The distributing structure of the invention may therefore be suitable advantageously for mobile applications, in vehicles, for example, or else for stationary applications, in generators, for example.

The concept of the invention here is that a particle-based microporous layer is produced in the form of a film or web, incorporating fibrous particles that have been mixed in. In the plane of extent (x, y) of the microporous layer, therefore, the particle-based microporous layer has a higher (effective) diffusion coefficient in a first planar direction (x) than in a second planar direction (y). Viewed in a vertical direction (z) in relation to the plane of extent (x, y) of the microporous layer, i.e., in the stacking direction of the fuel cell stack, the distributing structure may have a third (effective) diffusion coefficient, which may be greater than or equal to the second (effective) diffusion coefficient.

Surprisingly it has emerged that in the case of proportional use of fibrous materials within the particulate microporous layer, the structure of the remaining materials, such as the particles, more particularly of carbon fibers, optionally conductivity-additive binders, but also, in particular, of the pores between the particles, is aligned along the fibers. The materials may be mixed beforehand, homogeneously, for example. The mixture may be produced by way of a process, such as, for example, initially stirring or kneading and subsequent or exclusive shaping such as, for example, knife coating, slot casting, extruding or pressing, optionally with the aid of a fluidizing assistant, a solvent and/or a binder, preferably continuously in the form of a film, foil or web. Accordingly it is possible to configure gas diffusion pathways for the reactants preferentially in the plane of the film or of the foil or of the web.

By means of the invention, a considerable improvement is achieved in mass transfer between fuel cell catalyst layer and the gas channels, including under the webs of the bipolar plates. As a result of doing away with the fiber-based gas diffusion layers (GDL), it is possible to save on costs for material and for producing the fibrous gas diffusion layers. This also enables a substantial reduction in the footprint and in the weight of the fuel cell. Furthermore, it is possible as a result to improve the transport of heat from the fuel cell (owing to a greater physical density of the microporous layer in comparison to a fibrous gas diffusion layer) for higher power densities.

In the case of a distributing structure, the invention may further provide that the distributing structure has a third diffusion coefficient in a vertical direction in relation to the plane of extent of the microporous layer, where the third diffusion coefficient is greater than or equal to the second diffusion coefficient. In this way the distribution of gas within the fuel cell may be carried out preferably in the plane of extent of the microporous layer. At the same time this allows the transport of heat from the fuel cell into the stacking direction of the fuel cell stack to be improved.

In the case of a distributor structure, furthermore, the invention may provide that the particles comprise a carbon material, carbon black and/or graphite. It is possible accordingly to provide conductive and stable particles in order to provide mechanical stability and electrical conductivity of the distributing structure.

In the case of a distributor structure, furthermore, the invention may provide that the fibers comprise carbon fibers and/or graphite fibers. It is therefore possible to use industrially producible fibers, which are used as usual for a fiber-based gas diffusion layer.

In the case of a distributor structure, furthermore, the invention may provide that the particles have a substantially round or oval shape. It is therefore possible to utilize particles which are used as usual for a microporous layer. Through an oval shape, the orientation of the particles and preferably of the pores into the fiber direction can be promoted, in order to obtain a higher diffusion coefficient in a preferential direction (here referred to as the first planar direction).

In the case of a distributor structure, moreover, the invention may provide that the particles have a diameter of up to 50 µm, more particularly of 5 nm to 30 µm, preferably 10 nm to 10 µm. The particles may also take the form of agglomerates. It is therefore possible to provide an advantageous particle size with a sufficient porosity between the particles within the microporous layer.

In the case of a distributing structure, furthermore, the invention may provide that the fibers have a diameter of 2 µm to 20 µm, more particularly 5 µm to 10 µm, preferably 6-8 µm. Moreover, in the case of a distributor structure, the invention may provide that the fibers have a length of 10 µm to 6 mm, more particularly 10 µm to 500 µm, preferably 50 µm to 200 µm. It is therefore possible to provide fibers which influence the orientation of the particles and pores and which are able to provide sufficient porosity between the particles and the fibers within the microporous layer.

In the case of a distributor structure, furthermore, the invention may provide that the pores are produced by particulate pore formers and/or by fibrous pore formers. In this way it is possible to provide particulate and/or fibrous regions within the microporous layer that are able to promote the gas transport and the outward transport of product water.

In the case of a distributor structure, moreover, the invention may provide that the particulate pore formers and/or the fibrous pore formers comprise sugars, salts, polyethylene glycols, polyvinylidene fluorides, more particularly polyvinylidene fluoride-hexafluoropropylene copolymers, polyvinyl alcohols, polyvinyl chlorides, polyethylenes, polypropylenes, polystyrenes, and/or that the configuration of the particulate pore formers and/or the fibrous pore formers is such that they are soluble in a solvent and/or dissoluble by a heat treatment or irradiation. In this way the pore structure within the microporous layer can be produced in a diversity of ways.

In the case of a distributor structure, furthermore, the invention may provide that the distributing structure comprises at least one or two or more binders, more particularly polyvinylidene fluoride and/or polytetrafluoroethylene, preferably in a total fraction of 1 to 40 weight percent, more particularly 2 to 30 weight percent, preferably 5 to 20 weight percent, and/or at least one or two or more auxiliaries and/or additives, such as radical scavengers, for example. In the case of the binder and/or in the case of the binder mixture, the PVDF fraction in the mixture may be between 40 and 100 weight percent. The microporous layer may accordingly be provided with diverse properties, which can be tailored according to desire and requirement.

In the case of a distributor structure, furthermore, the invention may provide that the self-supporting microporous film is produced by one of the following processes: knife coating process, more particularly on a carrier foil, slot casting, extruding or pressing. By means of such processes it is possible to enable simple and cost-effective production of the microporous layer with a micrometer physical thickness, which in particular may be greater than or equal to a diameter of the particles and/or may have only a few particle layers.

Furthermore, according to the second aspect, the invention provides a fuel cell which may comprise at least one distributing structure with anisotropic diffusion coefficient, which may be designed as described above. The fuel cell of the invention achieves the same advantages described above in connection with the distributing structure of the invention. These advantages are presently referenced in their entirety.

### BRIEF DESCRIPTION OF THE DRAWINGS

The invention and developments thereof and also the advantages thereof are elucidated in more detail below by means of drawings, in which, in each case schematically:

FIG. 1 shows a schematic representation of a distributing structure in the sense of the invention at the production stage, by means of a knife coating operation, for example;

FIG. 2 shows a schematic representation of a distributing structure in the sense of the invention in a plan view, in a cross section, and in a longitudinal section;

FIG. 3 shows a schematic representation of a distributing structure in the sense of the invention at the production stage, more particularly during pore formation; and

FIG. 4 shows a schematic representation of a fuel cell in the sense of the invention.

### DETAILED DESCRIPTION

Across the various figures, identical parts of the invention are always provided with the same reference symbols, and for that reason are generally described only once.

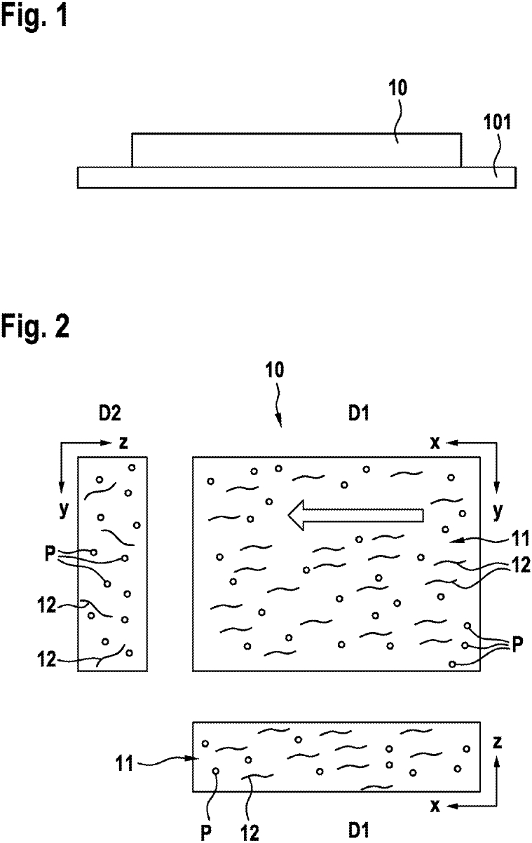

FIGS. 1 to 3 show a distributing structure 10 in the sense of the invention for a fuel cell 1, which is shown illustratively in FIG. 4. The fuel cell 1 likewise forms an aspect of the invention, like the distributing structure 10.

FIG. 2 serves to illustrate the structure of the distributing structure 10 in the sense of the invention, which is configured in the form of a microporous layer, more particularly a self-supporting microporous layer, having a multiplicity of particles 11. These particles 11 are designed for providing mechanical stability and electrical conductivity of the distributing structure 10. Configured between the particles 11 are a multiplicity of pores P for distributing reactants through the distributing structure 10 and for taking off product water.

In the case of the distributing structure 10, the invention provides a multiplicity of fibers 12 which are apparent in the plan view of the plane of extent x, y of the microporous layer and in the longitudinal section x, z along a first planar direction x.

This first planar direction x is so called only illustratively. What is important is that the first planar direction x lies in the plane of extent x, y of the microporous layer. The first planar direction x is governed by an orientation of the fibers 12 within the distributing structure 10. The first planar direction x may be governed by production - for example, by a knife coating direction or by an extrusion direction.

The fibers 12 of the invention may be provided proportionally in relation to the particles 11, for example in a ratio, for example in a weight ratio or mass ratio, of 0.1:1 to 10:1, more particularly 0.5:1 to 5:1, preferably 1:2 to 2:1.

The fibers 12 of the invention are distributed within the microporous layer, more particularly mixed with the particles 11, in such a way that the distributing structure 10 has a first diffusion coefficient D1 in the first planar direction x in relation to the plane of extent x, y of the microporous layer and that the distributing structure 10 has a second diffusion coefficient D2 in a second planar direction y in relation to the plane of extent x, y of the microporous layer, where the first diffusion coefficient D1 is higher than the second diffusion coefficient D2.

The fibers 12 of the invention may be provided by elongate particulate materials and also by fibrous materials.

As already mentioned above and as indicated illustratively in FIG. 1, the microporous layer of the invention may be produced as a film, foil or web, which may be trimmed to shape, in order to provide one or two or more microporous layers for one or two or more fuel cells 1 in the sense of FIG. 4.

The microporous layer of the invention is advantageously self-supporting, allowing the distributing structure 10 of the invention to be handled individually before it may be disposed between a bipolar plate BPP and a catalyst layer K of a membrane M within the fuel cell 1, as shown by FIG. 4.

By means of the distributing structure 10 of the invention it is possible to forgo a fibrous gas diffusion layer (GDL) within a fuel cell 1.

The distributing structure 10 of the invention may be disposed at least on one cathode side and optionally on an anode side of the fuel cell 1, or on the anode side and optionally on the cathode side.

The fuel cell 1 of the invention may further be stacked to form a fuel cell stack, with multiple fuel cells, preferably PEM fuel cells.

The distributing structure 10 of the invention may be used with particular advantage for mobile applications, such as in vehicles, but also for stationary applications, such as in generators, for example.

In the plane of extent x, y of the microporous layer, the particle-based microporous layer therefore has a higher diffusion coefficient in the first planar direction x than in a second planar direction y. Accordingly gas diffusion pathways for the reactants can be configured preferentially in the plane of extent x, y of the microporous layer.

In a vertical direction z in relation to the plane of extent x, y of the microporous layer or in a stacking direction of the fuel cell stack, the distributing structure 10 may have a third diffusion coefficient D3, which may be greater than or equal to the second diffusion coefficient D2. In this way the gas may be distributed within the fuel cell 1 primarily in the plane of extent x, y of the microporous layer. As a result it is simultaneously possible to improve the transport of heat from the fuel cell 1 into the vertical direction z of the fuel cell 1.

The invention registers a surprising advantage in the use of fibrous materials within the particulate microporous layer. In this case the structure of the other materials, such as the particles 11, optionally conductivity-additive binders, but also, in particular, the pores P between the particles 11, is oriented along the fibers 12.

The individual materials of the particulate microporous layer may be mixed beforehand, homogeneously, for example. The mixture — homogeneous mixture, for example —may be produced via a process, such as knife coating on a carrier foil 101 (in this regard see FIG. 1), for example, or else by slot casting, extruding or pressing.

At the mixing stage it is possible optionally to use fluidizing agents, dispersants, solvents and/or binders in order to facilitate the production of the distributing structure 10.

The distributing structure 10 of the invention substantially improves mass transfer between catalyst layer K of the fuel cell 1 and the gas channels, including under the webs of the bipolar plates BPP.

As a result of the fiber-based gas diffusion layers (GDL) being done away with, it is possible to save on costs for material and for production for the fibrous gas diffusion layers. This also enables a reduction in the footprint and the weight of the fuel cell 1. Furthermore, it is possible as a result to improve the transport of heat from the fuel cell 1 for higher power densities, because a microporous layer can have a higher physical density than a fibrous gas diffusion layer.

The particles 11 may comprise a carbon material, carbon black and/or graphite. The particles 11 may have a substantially round or oval shape. The particles 11 may also have a diameter of up to 50 µm, more particularly of 5 nm to 30 µm, preferably 10 nm to 10 µm. The particles may also take the form of agglomerates.

The fibers 12 may comprise carbon fibers and/or graphite fibers. The fibers 12 may have a diameter of 2 µm to 20 µm, more particularly 5 µm to 10 µm, preferably 6-8 µm. The fibers 12, moreover, may have a length of 10 µm to 6 mm, more particularly 10 µm to 500 µm, preferably 50 µm to 200 µm.

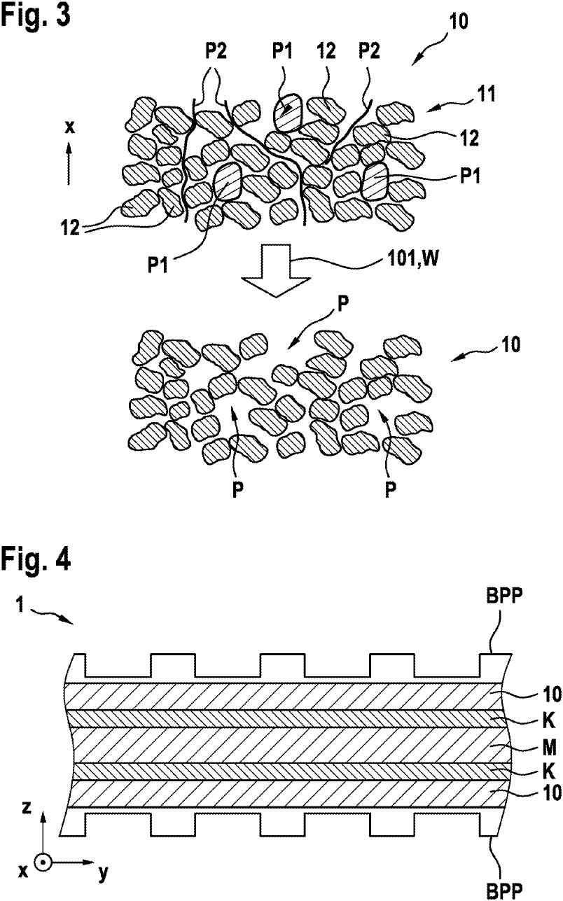

As indicated illustratively by FIG. 3, the pores P may have been produced by particulate pore formers P1 and/or by fibrous pore formers P2. In the context of the invention it is conceivable for the pore formers P1, P2 to have a possible configuration such that they are volatile, being soluble for example in a solvent 102 or dispersion medium, or insoluble but dissoluble by a heat treatment W or irradiation L.

Pore formers P1, P2 conceivable in the sense of the invention are sugars, salts, polyethylene glycols, polyvinylidene fluorides, more particularly polyvinylidene fluoride-hexafluoropropylene copolymers, polyvinyl alcohols, polyvinyl chlorides, polyethylenes, polypropylenes, polystyrenes.

Moreover the distributing structure 10 may comprise at least one or two or more binders, such as polyvinylidene fluoride and/or polytetrafluoroethylene, for example, preferably in a total fraction of 1 to 40 weight percent, more particularly 2 to 30 weight percent, preferably 5 to 20 weight percent, and/or at least one or two or more auxiliaries and/or additives, such as radical scavengers, for example.

The above description of the figures describes the present invention exclusively as part of examples. It will be appreciated that, as far as is technically rational, individual features of the embodiments may be combined freely with one another without departing from the scope of the invention.

1. A distributing structure (10) for a fuel cell (1), in the form of a microporous layer, comprising:
a multiplicity of particles (11),
where the particles (11) are designed for providing mechanical stability and electrical conductivity of the distributing structure (10),
and where between the particles (11) a multiplicity of pores (P) are configured for distributing reactants (H2, O2) through the distributing structure (10) and for taking off product water (H2O),
wherein a multiplicity of fibers (12) are provided which are distributed within the microporous layer in such a way
that the distributing structure (10) has a first diffusion coefficient (D1)in a first planar direction (x) in relation to a plane of extent (x, y) of the microporous layer
and that the distributing structure (10) has a second diffusion coefficient (D2) in a second planar direction (y) in relation to the plane of extent (x, y) of the microporous layer,
where the first diffusion coefficient (D1) is higher than the second diffusion coefficient (D2).

2. The distributing structure (10) as claimed in claim 1,
wherein the distributing structure (10) has a third diffusion coefficient (D3) in a vertical direction (z) in relation to the plane of extent (x, y) of the microporous layer,
where the third diffusion coefficient is greater than or equal to the second diffusion coefficient (D2).

3. The distributing structure (10) as claimed in claim 1,
wherein the particles (11) comprise a carbon material, carbon black and/or graphite.

4. The distributing structure (10) as claimed in claim 1,
wherein the fibers (12) comprise carbon fibers and/or graphite fibers,
and/or wherein the fibers (12) are provided proportionally to the particles (11) in a ratio of 0.1:1 to 10:1.

5. The distributing structure (10) as claimed in claim 1,
wherein the particles (11) have a substantially round or oval shape,
and/or wherein the particles (11) have a diameter of up to 50 µm,
and/or wherein the particles (11) are designed as agglomerates.

6. The distributing structure (10) as claimed in claim 1,
wherein the fibers (12) have a diameter of 2 µm to 20 µm,
and/or wherein the fibers (12) have a length of 10 µm to 6 mm.

7. The distributing structure (10) as claimed in claim 1,
wherein the pores (P) are produced by particulate pore formers (P1) and/or by fibrous pore formers (P2).

8. The distributing structure (10) as claimed in claim 7 ,
wherein the particulate pore formers (P1)and/or the fibrous pore formers (P2) comprise sugars, salts, polyethylene glycols, polyvinylidene fluorides, polyvinyl alcohols, polyvinyl chlorides, polyethylenes, polypropylenes, polystyrenes,
and/or wherein the configuration of the particulate pore formers (P1)and/or the fibrous pore formers (P2) is such that they are soluble in a solvent and/or dissoluble by a heat treatment (W) or irradiation (L).

9. The distributing structure (10) as claimed in claim 1,
wherein the distributing structure (10) comprises at least one or two or more binders, and/or comprises at least one or two or more auxiliaries and/or additives.

10. The distributing structure (10) as claimed in claim 1,
wherein the self-supporting microporous film is produced by one of the following processes: knife coating process, slot casting, extruding or pressing.

11. A fuel cell (1) comprising at least one distributing structure (10) as claimed in claim 1.

12. The distributing structure (10) as claimed in claim 4,
wherein the fibers (12) are provided proportionally to the particles (11) in a ratio of 0.5:1 to 5:1.

13. The distributing structure (10) as claimed in claim 4,
wherein the fibers (12) are provided proportionally to the particles (11) in a ratio of 1:2 to 2:1.

14. The distributing structure (10) as claimed in claim 5,
wherein the particles (11) have a diameter of 5 nm to 30 µm.

15. The distributing structure (10) as claimed in claim 5,
wherein the particles (11) have a diameter of 10 nm to 10 µm.

16. The distributing structure (10) as claimed in claim 6,
wherein the fibers (12) have a diameter of 5 µm to 10 µm,
and/or wherein the fibers (12) have a length of 10 µm to 500 µm.

17. The distributing structure (10) as claimed in claim 8,
wherein the particulate pore formers (P1)and/or the fibrous pore formers (P2) comprise polyvinylidene fluoride-hexafluoropropylenecopolymers.

18. The distributing structure (10) as claimed in claim 9,
wherein the binders are polyvinylidene fluoride and/or polytetrafluoroethylene, and the at least one or two or more auxiliaries and/or additives include radical scavengers.

19. The distributing structure (10) as claimed in claim 9, wherein the binders are in a total fraction of 1 to 40 weight percent.

20. The distributing structure (10) as claimed in claim 9, wherein the binders are in a total fraction of 2 to 30 weight percent.
